(19) United States
(12) Patent Application Publication
(10) Pub. No.: US 2025/0365548 A1
(43) Pub. Date: Nov. 27, 2025

(54) METHODS, SYSTEMS AND APPARATUS FOR ACCOUSTIC 3D EXTENT MODELING FOR VOXEL-BASED GEOMETRY REPRESENTATIONS

(71) Applicant: DOLBY INTERNATIONAL AB, Dublin (IE)

(72) Inventors: Panji SETIAWAN, Munich (DE); Leon TERENTIV, Erlangen (DE); Daniel FISCHER, Fuerth (DE); Christof Joseph FERSCH, Neumarkt (DE)

(73) Assignee: DOLBY INTERNATIONAL AB, Dublin (IE)

(21) Appl. No.: 18/875,104

(22) PCT Filed: Jun. 13, 2023
(86) PCT No.: PCT/EP2023/065704

§ 371 Date: Dec. 13, 2024

Related U.S. Application Data
(60) Provisional application No. 63/352,360, filed on Jun. 15, 2022.
(60) Provisional application No. 63/441,120, filed on Jan. 25, 2023.

(51) Int. Cl. H04S 7/00; G10L 19/008

(52) U.S. Cl. CPC H04S 7/303; G10L 19/008; H04S 2400/11

(57) ABSTRACT

Described herein is a method of rendering audio in an audio scene. The method comprises receiving a voxel-based audio scene representation of the audio scene, the audio scene representation including an indication of extent voxels representing a 3D extent together with a plurality of audio source signals for audio sources associated with the 3D extent; obtaining coordinates of an intersection point inside the 3D extent; determining one or more line-segments running through the intersection point and extending along respective coordinate directions of the audio scene representation, wherein end points of each line segment are determined based on coordinates of one or more of the extent voxels; and allocating audio sources among the plurality of audio sources to audio source locations within the audio scene based on the one or more line-segments. Further described are a respective apparatus and computer program product.

### CROSS-REFERENCE TO RELATED APPLICATION

This application claims priority of the U.S. Provisional Application No. 63/352,360 filed Jun. 15, 2022, and U.S. Provisional Application No. 63/441,120 filed on Jan. 25, 2023, all of which is incorporated herein by reference in its entirety.

### TECHNICAL FIELD

The present disclosure relates generally to a method of rendering audio in an audio scene, in particular based on a voxel-based audio scene representation of the audio scene. The present disclosure relates further to a respective apparatus and computer program product.

While some embodiments will be described herein with particular reference to that disclosure, it will be appreciated that the present disclosure is not limited to such a field of use and is applicable in broader contexts.

### BACKGROUND

Any discussion of the background art throughout the disclosure should in no way be considered as an admission that such art is widely known or forms part of common general knowledge in the field.

The Moving Picture Experts Group (MPEG) is an alliance of working groups established jointly by the International Organization for Standardisation (ISO) and International Electrotechnical Commission (IEC), that sets standards for media coding, including audio coding. MPEG is organized under ISO/IEC SC 29, and the audio group is presently identified as working group (WG) 6. WG 6 is currently working on the MPEG-I Audio standard.

The new MPEG-I standard enables an acoustic experience from different viewpoints and/or perspectives or listening positions by supporting scenes and various movements around such scenes, such as movements using various degrees of freedom such as three degrees of freedom (3DOF) or six degrees of freedom (6DoF) in Virtual reality (VR), augmented reality (AR), mixed reality (MR) and/or extended reality (XR) applications. A 6DoF interaction extends a 3DoF spherical video/audio experience that is limited to head rotations (pitch, yaw, and roll) to include translational movement (forward/back, up/down, and left/right), to allow for navigation within a virtual environment (e.g., physically walking inside a room), in addition to the head rotations.

For audio rendering in VR, AR, MR and XR applications, object-based approaches have been widely employed by representing a complex auditory scene as multiple separate audio objects, each of which is associated with parameters or metadata defining a location/position and trajectory of that object in the scene. Alternatively audio rendering in such environments also uses higher order Ambisonics (HOA).

Audio objects are usually represented as point sources (having no extent). As used herein, an audio source with an “extent” is audio source waveform(s) associated with a spatial region (where the region is larger than a point). For example, a piano can be represented as audio source(s) (e.g., a stereo or mono L/R) with a cuboid extent instead of merely a point source.

The use of an extent allows for improvement of a user's audio experience, for example, when a user is around the virtual piano object in a VR, AR, MR or XR environment. In this example, the extent that represents the piano for audio rendering does not need to have exact physical details as a real piano.

To reflect the acoustic effect of audio objects with an extent, such an audio object may be represented by a voxel-based geometry. Voxels for audio rendering are relevant for media environments implemented in both hardware and software, such as video game and/or VR, AR, MR and XR environments.

There is, however, still an existing need for improved rendering of the acoustic effect of a 3D extent that is represented by voxel-based geometries, in particular, it may be desirable to simplify the process and to reduce the computational burden.

### SUMMARY

In view of the above, the present disclosure provides methods, apparatus, and programs, as well as computer-readable storage media for rendering audio in an audio scene, having the features of the respective independent claims.

In accordance with a first aspect of the present disclosure there is provided a method of rendering audio in an audio scene. The method may comprise receiving a voxel-based audio scene representation of the audio scene. The audio scene representation may include an indication of extent voxels representing a 3D extent together with a plurality of audio source signals for audio sources associated with the 3D extent. The method may further comprise obtaining (e.g., determining, calculating) coordinates of an intersection point inside the 3D extent. The method may further comprise determining one or more line-segments running through the intersection point and extending along respective coordinate directions of the audio scene representation. End points of each line segment may be determined based on coordinates of one or more of the extent voxels. And the method may comprise allocating audio sources among the plurality of audio sources to audio source locations within the audio scene based on the one or more line-segments.

In some embodiments, the intersection point may be one of the geometric center of the 3D extent and the center of gravity of the 3D extent.

In some embodiments, end points of each line segment may be determined based on extremal coordinate values of the 3D extent along respective coordinate directions, such that lengths of the line segments correspond to maximum dimensions of projections of the 3D extent onto respective coordinate directions.

In some embodiments, the audio scene representation may further indicate occluder voxels. Allocating the audio sources may include allocating the audio sources to coordinates within voxels other than the occluder voxels.

In some embodiments, the audio scene representation may further indicate unfilled voxels (e.g., air voxels). Allocating the audio sources may include allocating the audio sources to coordinates on respective line segments that are closest to the end points of the respective line segments and that are within extent voxels or unfilled voxels.

In some embodiments, allocating the audio sources may further include determining one or more possible target locations for allocating the audio sources, based on the line segments.

In some embodiments, the audio scene representation may further indicate unfilled voxels (e.g., air voxels). Determining the one or more possible target locations may include selecting coordinates for the one or more possible target locations that are closest to the end points of the respective line segments and that are within extent voxels or unfilled voxels.

In some embodiments, determining the one or more possible target locations may include selecting coordinates for the one or more possible target locations that are closest to the end points of the respective line segments and that are within extent voxels.

In some embodiments, the method may further include selecting the audio source locations from the possible target locations based on a predefined minimum distance between audio sources. And the method may include allocating the audio sources among the plurality of audio sources to the selected audio source locations.

In some embodiments, the method may further include obtaining a mapping indicating an assignment of the audio source signals to the audio source locations.

In some embodiments, the method may further include assigning gains to the audio source locations based at least in part on the mapping.

In some embodiments, the method may further include obtaining coordinates of a listener location. And the method may include rendering audio source signals of the allocated audio sources based on a reference distance between the listener position and the 3D extent.

In some embodiments, the rendering may further include rendering the audio source signals based on occlusion and diffraction modeling.

In accordance with a second aspect of the present disclosure there is provided an apparatus for rendering audio in a voxel-based audio scene representation. The apparatus may include one or more processors configured to carry out a method that may include receiving a voxel-based audio scene representation of the audio scene, the audio scene representation including an indication of extent voxels representing a 3D extent together with a plurality of audio source signals for audio sources associated with the 3D extent. The method that may further include obtaining coordinates of an intersection point inside the 3D extent. The method may further include determining one or more line-segments running through the intersection point and extending along respective coordinate directions of the audio scene representation. End points of each line segment may be determined based on coordinates of one or more of the extent voxels. And the method may include allocating audio sources among the plurality of audio sources to audio source locations within the audio scene based on the one or more line-segments.

Aspects of the present disclosure may be implemented via an apparatus. The apparatus may include a processor and memory coupled to the processor. The processor may be adapted to carry out the method according to aspects and embodiments of the present disclosure.

Aspects of the present disclosure may be implemented via a program. When instructions of the program are executed by a processor, the processor may carry out aspects and embodiments of the present disclosure. A computer-readable storage medium may store the program. Such computer-readable storage media may include memory devices such as those described herein, including but not limited to random access memory (RAM) devices, read-only memory (ROM) devices, etc. Accordingly, some innovative aspects of the subject matter described in this disclosure can be implemented via one or more computer-readable storage media having software stored thereon.

It will be appreciated that apparatus features and method steps may be interchanged in many ways. In particular, the details of the disclosed method(s) can be realized by the corresponding apparatus (or system), and vice versa, as the skilled person will appreciate. Moreover, any of the above statements made with respect to the method(s) are understood to likewise apply to the corresponding apparatus (or system), and vice versa.

### BRIEF DESCRIPTION OF THE DRAWINGS

Example embodiments of the disclosure will now be described, by way of example only, with reference to the accompanying drawings in which:

FIG. 1 illustrates an example of a method of rendering audio in an audio scene according to embodiments of the disclosure,

FIG. 2 illustrates an example of a voxel-based audio scene representation of an audio scene according to embodiments of the disclosure,

FIG. 3 illustrates an example of allocating audio sources to audio source locations within an audio scene according to embodiments of the disclosure,

FIG. 4 illustrates another example of allocating audio sources to audio source locations within an audio scene according to embodiments of the disclosure,

FIGS. 5-9 illustrate an exemplary use case of an example of a method of rendering audio in an audio scene according to embodiments of the disclosure,

FIG. 10 illustrates an example of a reference distance between a listener position and a 3D extent as well as an example of occlusion and diffraction modeling according to embodiments of the disclosure, and

FIG. 11 illustrates an example of an apparatus including one or more processors according to embodiments of the disclosure.

In the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the present disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths, as may be needed, to affect the communication.

### DESCRIPTION OF EXAMPLE EMBODIMENTS

An audio source with an extent is an audio source waveform(s) associated with a spatial region (larger than point). The spatial region can be modelled by a geometry (2D or 3D). A voxel is a 3D volume representation and therefore capable of modelling such a geometry. The use of voxels for audio rendering is relevant for a variety of media environments implemented in both hardware and software, such as video game and/or VR, AR, MR and XR environments. A voxel is a space volume with acoustic properties or audio rendering instructions assigned to it. Voxel size is an encoder configuration parameter, and it can be (manually or automatically) selected according to a scene geometry level of details (e.g., in the range of 10 cm-1 m). Voxels for audio rendering can be obtained by:
voxelization (or conversion) of a mesh-based scene representation;
from a scene representation used for scene generation (or even video rendering), e.g., by down-sampling of voxels of smaller size.

Methods and apparatus as described herein are concerned with how to render the acoustic effect of a 3D extent, when the 3D extent is represented by voxel-based geometries. More specifically, methods and apparatus as described herein are concerned with how to obtain coordinates of ‘joint’ (point) audio sources.

Typically, more than one audio source is needed to model audio sources with an extent to approximate the spatial region of the extent. These (target) audio sources may be derived from given audio source(s) associated with the extent, specified by a scene creator using, e.g., a scene description. The word ‘joint’, as used herein, may be said to imply that these target sources are related to each other since they are representing the spatial region of the extent in one dimension. As there are three dimensions, at least a pair of audio sources is needed per dimension. As an example, a scene description specifies a stereo channel with a cuboid extent to represent a virtual piano object. Processing may then be done at a renderer to derive three pairs of ‘joint’ “target” audio sources placed in six different positions within the extent proximity.

That is, methods and apparatus as described herein aim at finding (e.g., selecting, determining) a respective number of (point) audio sources, e.g., N=[1, . . . , 6] and their coordinates (locations) P^{1, . . . , N} and mapping audio signals S^{1, . . . , M} to the respective positions P^{1, . . . , N} and gains based on a given scene description including, for example, listener position coordinates L, 3D extent material IDs (representing audio object 3D extent geometry approximation), a set of 3D grid indices VOX (representing set of the 3D extent) and a set of M audio signals (mono, stereo, etc.) as well as modelling settings including, for example, a minimal distance Δₘᵢₙ between two ‘joint’ (point) audio sources, a mapping matrix F to assign audio signals to obtained point source position (and gains) and a reference distance.

Methods and apparatus as described herein allow to model audio objects with an extent represented by voxel-based geometries, without explicitly signaling audio source coordinates (e.g., without explicitly transmitting and receiving this information in a bitstream). That is, methods and apparatus as described herein may be said to emphasize the way the ‘joint’ audio source coordinates (positions) are being determined within the extent proximity, assuming that the extent is represented by voxel-based geometries. The resulting locations/coordinates are voxel coordinates. As they are computed at the renderer side, there is no need to know them in advance and an explicit signaling/transmission is not needed.

Advantageously, this allows obtaining signal audio source coordinates automatically for complex voxel-based 3D extent geometries at the decoder side, particularly when the decoder operates in a manner compliant with an audio standard, such as a standard set by MPEG. Another advantage is that this allows support of 3D extent geometry modifications at the decoder (without the need of re-encoding the modified scene).

An encoding of a 3D extent geometry is done at the encoder and transmitted to the decoder to deliver the information on the extent geometry to the decoder/renderer. An extent, as with many other objects in the scene, can be modified, either at the encoder or decoder/renderer side. A modification at the encoder requires the “re-encoding” of the extent to be transmitted to the decoder. This does not apply to the decoder/renderer side modification. As the methods described herein are implemented at the decoder/renderer side, i.e. any modification to the extent is done at the decoder/renderer side, the “re-encoding” is not required.

### How to Represent Voxel-Based Audio Scenes?

Any voxel-based representation of an audio scene may contain an indication of voxels that are not transmission voxels (e.g., that are occluder voxels), i.e., voxels in which sound cannot propagate or cannot freely propagate—a representation of occluding geometries. This indication may relate to an indication of coordinates (e.g., center coordinates, corner coordinates, etc.) of the respective voxels. The coordinates of these voxels may be represented by grid indices, for example. Additionally, the voxel-based representation may include indications of material properties of the voxels that are not transmission voxels, such as absorption coefficients, reflection coefficients, etc. In addition to the occluder voxels, the voxel-based representation may also indicate transmission voxels or unfilled voxels (e.g., air voxels), i.e., voxels in which sound can propagate—a representation of sound propagation media. Accordingly, some implementations of voxel-based representations of audio scenes may include, for each voxel in a predefined section of space (e.g., within boundaries enclosing the audio scene), an indication of a respective material property.

### Method of Rendering Audio in an Audio Scene

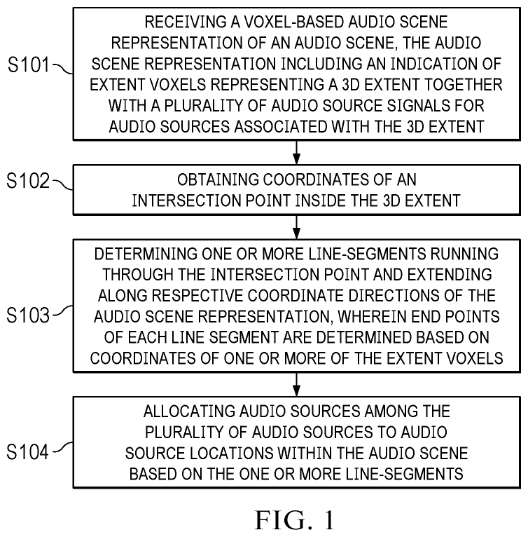

Referring to FIG. 1, an example of a method of rendering audio in an audio scene is illustrated. The method is performed at the decoder/renderer side and may be implemented by a respective decoder/renderer. For example, all method steps may be performed in real-time in a single device that may be a VR/AR/MR/XR device.

In step S101, a voxel-based audio scene representation of the audio scene is received. The audio scene representation includes an indication of extent voxels representing a 3D extent together with a plurality of audio source signals for audio sources associated with the 3D extent. In other words, the 3D extent may be said to correspond to an audio object with extent having a geometric form that is represented by the extent voxels.

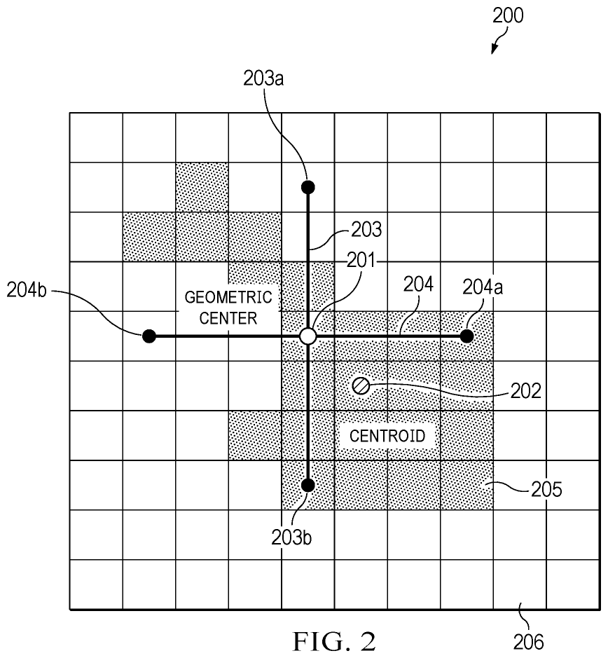

An example of a voxel-based audio scene representation of an audio scene is illustrated schematically in FIG. 2. The example of FIG. 2 is a 2D cut through a voxel-based 3D audio scene representation including a 3D extent. FIG. 2 shows a grid pattern that represents the voxelization of the audio scene representation. In the example of FIG. 2, according to an embodiment, extent voxels, 205, and unfilled voxels (e.g., air voxels), 206 are indicated. That is, besides the extent voxels representing the 3D extent, the audio scene representation may also indicate voxels representing part of the acoustic environment of the 3D extent. Unfilled voxels may be said to represent a sound transmission medium. A sound transmission medium may be air and/or water, for example.

Referring again to the example of FIG. 1, in step S102 coordinates of an intersection point inside the 3D extent are obtained (e.g., determined, calculated). In an embodiment, the intersection point may be one of the geometric center of the 3D extent and the center of gravity of the 3D extent. In the example of FIG. 2, the geometric center of the 3D extent, 201, and the center of mass of the 3D extent (centroid), 202, which can be used alternatively, are schematically illustrated.

In a manner not intended to be limiting, the intersection point may be made to be the origin O of a cartesian coordinate system. In the context of the example of a cartesian coordinate system, the intersection point (3D extent center) C_{x,y,z} of the voxel-based 3D extent representation VOX_{x,y,z}, may then be determined using the “min/max” approach as follows:

$${C}_{x , y , z} = round ( \vert {V}_{x , y , z}^{max} - {V}_{x , y , z}^{min} \vert / 2 ) \\ where {V}_{x , y , z}^{max} = max ( {VOX}_{x , y , z} ) , {V}_{x , y , z}^{min} = min ( {VOX}_{x , y , z} )$$

Here, it is understood that the above equation separately applies to coordinates x, y, and z, i.e., that there is one such equation for each coordinate. Note that it is also possible to use the “center of gravity” method or others.

Referring again to the example of FIG. 1, in step S103, one or more line-segments are determined that each run through the intersection point and that each extend along a respective coordinate direction of the audio scene representation (e.g., along x-, y-, and z-coordinate axes). The end points of each line segment are determined based on coordinates of one or more of the extent voxels. For example, as detailed below, the end points of each line segment may be determined based on extremal coordinate values of the 3D extent along the respective coordinate direction. That is, for example, for a line segment extending along the x coordinate axis, the end points may be determined based on extremal coordinates of the 3D extent along the x coordinate axis.

In the example of FIG. 2, in the 2D cut, two of such line segments, 203, 204, are illustrated running through the geometric center of the 3D extent, 201, and having the respective end points 203a, 203b, 204a, 204b. In case of a cartesian coordinate system, the lines may be the X, Y and Z axis lines (assuming that the intersection point is made the origin of the coordinate system) and the line segments may be segments of the X, Y and Z axis lines. In the 2D cut of FIG. 2, the line 203 may be the Y axis line and the line 204 may be the X axis line.

Referring again to the example of FIG. 1, in step S104, audio sources among the plurality of audio sources are allocated to audio source locations within the audio scene based on the one or more line-segments. “Allocated”, as used herein may be said to refer to the target audio sources being generated (e.g., based on the given/specified audio sources of an extent) and linked/mapped onto calculated coordinate locations. That is, in step S104, a set of target audio sources may be output that is placed on the calculated locations in the proximity of the extent. These target sources (instead of the given/specified audio sources that come with an extent) may be used to replace the task of rendering “audio sources with an extent” by rendering a set of point sources. The one or more line-segments are constructed to aid in the determination of the target audio source locations. Note that S103 outputs these line-segments.

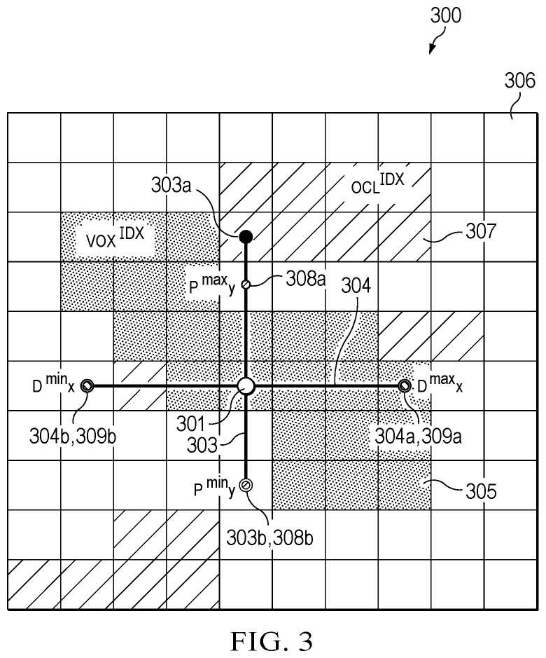

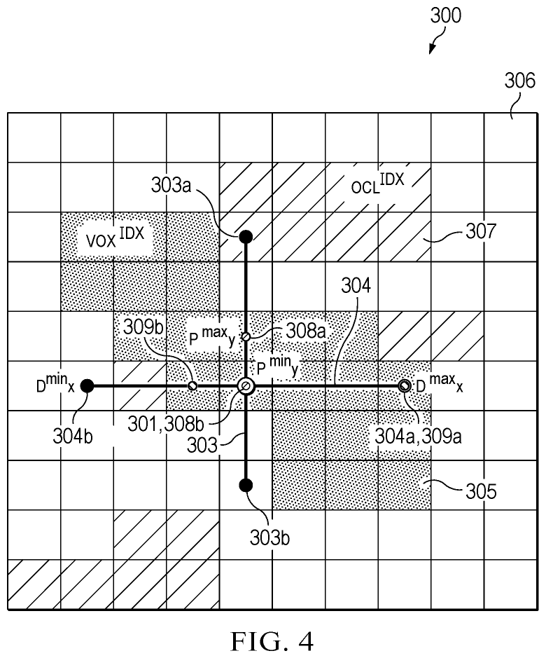

Referring now to FIG. 3 and FIG. 4, two examples of allocating audio sources to audio source locations within an audio scene are schematically illustrated. That is, FIG. 3 and FIG. 4 represent two possible implementations of method step S104. The implementations differ in the way the target source locations indicated by 308a, 308b, 309a, 309b, are determined.

Notably, FIG. 3 and FIG. 4 also represent respective 2D cuts.

FIG. 3 and FIG. 4 illustrate examples of indications of extent voxels, 305, unfilled voxels, 306, and occluder voxels, 307. Occluder voxels may represent acoustic occluders that exist, for example, between the 3D extent and a listener.

In some embodiments, end points of each line segment may be determined, at step S103, based on extremal coordinate values of the 3D extent along respective coordinate directions, such that lengths of the line segments may correspond to maximum dimensions of projections of the 3D extent onto respective coordinate directions.

As outlined above, the intersection point inside the 3D extent may be made to be the origin O of a cartesian coordinate system with the respective line segments representing segments of the X, Y and Z axis lines. In the context of the example of a cartesian coordinate system, the maximum dimensions of projections of the 3D extent onto respective coordinate directions (3D extent characteristic dimension extreme points) D^{max}_{x,y,z} and D^{min} _{x,y,z} may thus be determined (extracted) as follows:

$${D}_{x}^{max} = [ {V}_{x}^{max} , {C}_{y} , {C}_{z} ] , {D}_{x}^{min} = [ {V}_{x}^{min} , {C}_{y} , {C}_{z} ] , {D}_{y}^{max} = [ {C}_{x} , {V}_{y}^{max} , {C}_{z} ] , {D}_{y}^{min} = [ {C}_{x} , {V}_{y}^{min} , {C}_{z} ] , {D}_{z}^{max} = [ {C}_{x} , {C}_{y} , {V}_{z}^{max} ] , {D}_{z}^{min} = [ {C}_{x} , {C}_{y} , {V}_{z}^{min} ] .$$

It may, however, also be possible to use different characteristic dimension representations such as the offsets from the center representation.

Respective maximum dimensions, 303a, 303b, and 304a, 304b, are illustrated in the examples of FIG. 3 and FIG. 4.

In some embodiments such as in FIG. 3, allocating the audio sources (to audio source locations within the audio scene), at step S104, may include allocating the audio sources to coordinates within voxels (e.g., 308a) other than the occluder voxels 307. Occluder voxels 307 may affect the sound perceived by a listener at a respective listener position such that allocating the audio sources to coordinates within voxels other than the occluder voxels 307 allows rendering respective audio source signals of the allocated audio sources such that the sound as perceived by a listener appears realistic.

Further, in some embodiments such as in FIG. 4, allocating the audio sources (to audio source locations within the audio scene) may further include allocating the audio sources to coordinates on respective line segments that are closest to the end points of the respective line segments and that are within extent voxels or unfilled voxels (e.g., 308a, 308b, 309a, 309b in FIG. 4).

Alternatively or additionally to the aforementioned embodiments, allocating the audio sources may further include determining one or more possible target locations for allocating the audio sources, based on the line segments. Determining the one or more possible target locations may then include selecting coordinates for the one or more possible target locations that are closest to the end points of the respective line segments and that are within extent voxels or unfilled voxels. In a further embodiment, determining the one or more possible target locations may include selecting coordinates for the one or more possible target locations that are closest to the end points of the respective line segments and that are within extent voxels.

Depending on the use case, allocating the audio sources to coordinates within extent voxels or selecting respective coordinates for the one or more possible target locations that are closest to the end points of the respective line segments and that are within extent voxels may allow to render respective audio source signals such that the sound as perceived by a listener may appear more natural as compared to coordinates within unfilled voxels.

In the context of the example of a cartesian coordinate system, possible target locations (3D extent joint point source coordinates) P^{max}_{x,y,z}, 308a, 309a, and P^{min}_{x,y,z}, 308b, 309b may be selected as follows:
P^{max}ₓ=[p^{max}ₓ, C_{y}, C_{z}] is the voxel closest to D^{max}ₓ, on the line [D^{max}ₓ, D^{min}ₓ,) which is not an “occluder” voxel for this audio object;
p^{min}ₓ=[p^{min}ₓ, C_{y}, C_{z}] is the voxel closest to D^{min}ₓ on the line (D^{max}_{x,}, D^{min}] and which is not an “occluder” voxel for this audio object.

The same procedure may be applied to get P^{max}_{y,z} and P^{min}_{y,z}. A “not an occluder” voxel can be defined to be either P^{min}_{x,y,z}∈VOX_{x,y,z} (FIG. 4) or P^{max}_{x,y,z}∈VOX_{x,y,z}|AIR_{x,y,z} (FIG. 3), where AIR_{x,y,z} is a sound transmission medium (unfilled voxel) such as air and/or water.

In some embodiments, the method may further include selecting the audio source locations from the possible target locations based on a predefined minimum distance between audio sources. The method may then include allocating the audio sources among the plurality of audio sources to the selected audio source locations. For example, the number N=[1, . . . , 6] of (point) audio sources may be calculated by considering 3 variables:

$${W}_{x , y , z} = \vert {P}_{x , y , z}^{max} - {P}_{x , y , z}^{min} \vert$$

The ‘x-’, ‘y-’, ‘z-’ pair of audio sources p^{max}_{x,y,z} and P^{min}_{x,y,z} is considered for 3D extent modelling, if W_{x,y,z}>Δₘᵢₙ·Δₘᵢₙ may be the (desired) minimal distance between two ‘joint’ (point) audio sources. This allows to prevent phasing audio artifact caused by two correlated audio signals rendered too close to each other. If all W_{x,y,z}≤Δₘᵢₙ, then the 3D extent may not be modelled and the audio object may be represented by a single audio point source (N=1) positioned in the voxel C_{x,y,z}.

In an embodiment, the method may further include obtaining a mapping indicating an (e.g., intended or desired) assignment of the audio source signals to the audio source locations (or to possible target locations). For example, the following mapping of M audio signals S^{1, . . . , M} to position coordinates P^{1, . . . , 6} may be read from the bitstream payload:

TABLE 1
Example mapping

| | | Audio |
|---|---|---|
| # | Position | source |
| 1 | P^{max}ₓ | OBJ_ID_1 |
| 2 | P^{min}ₓ | OBJ_ID_2 |
| 3 | P^{max}_{y} | OBJ_ID_3 |
| 4 | P^{min}_{y} | OBJ_ID_4 |
| 5 | P^{max}_{z} | OBJ_ID_5 |
| 6 | P^{min}_{z} | OBJ_ID_6 |

In some embodiments, the method may further include assigning gains to the audio source locations. This assignment may be based at least in part on the aforementioned mapping. Appropriate signal gains may further be assigned based on the number of selected audio sources to ensure energy preservation.

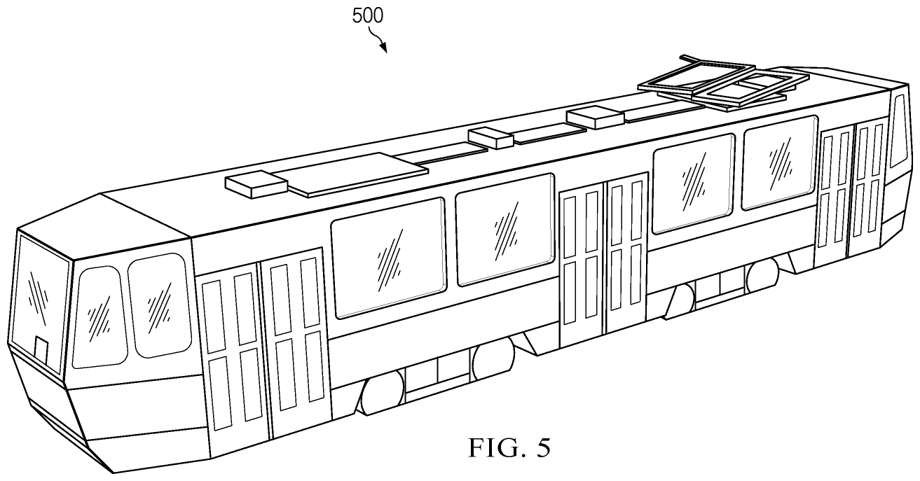

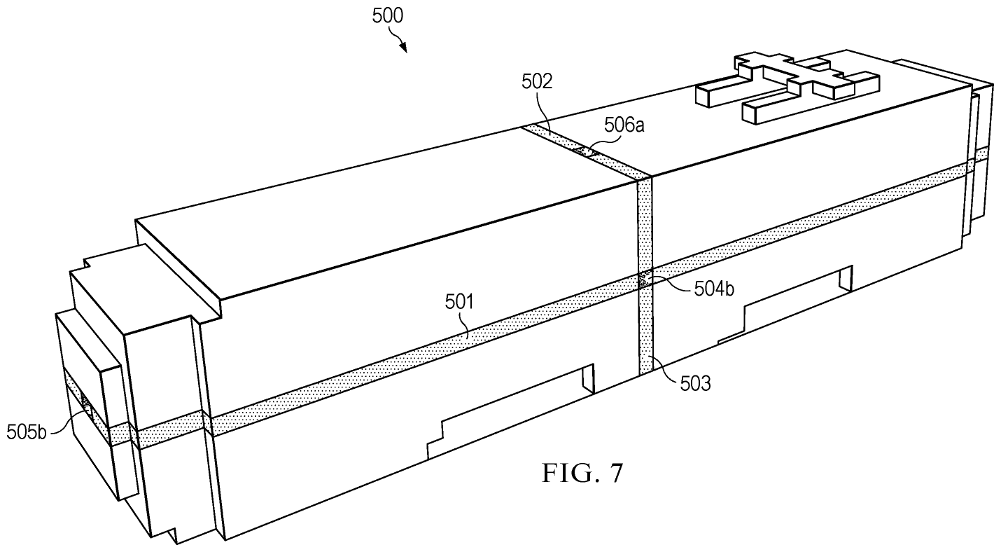

Referring now to the examples of FIG. 5 to FIG. 9, a use case of an example of a method of rendering audio in an audio scene as described herein is illustrated. In this example use case, the 3D extent to be rendered/modelled is exemplarily based on a tram, 500. FIG. 7 to FIG. 9 illustrate the respective ‘visible’ line segments, 501, 502, 503, and respective allocation coordinates/target location coordinates 504a, 504b, 505a, 505b, 506a, 506b which have been determined according to the method described herein.

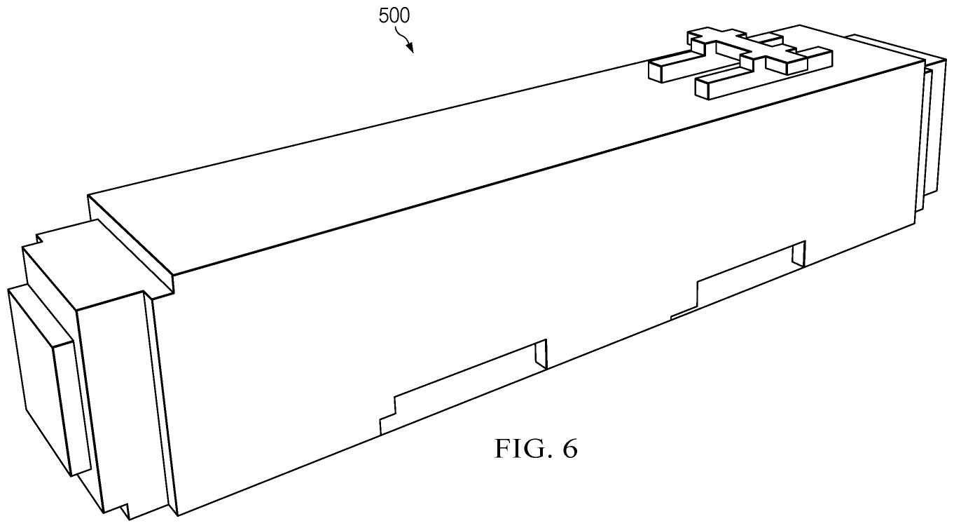

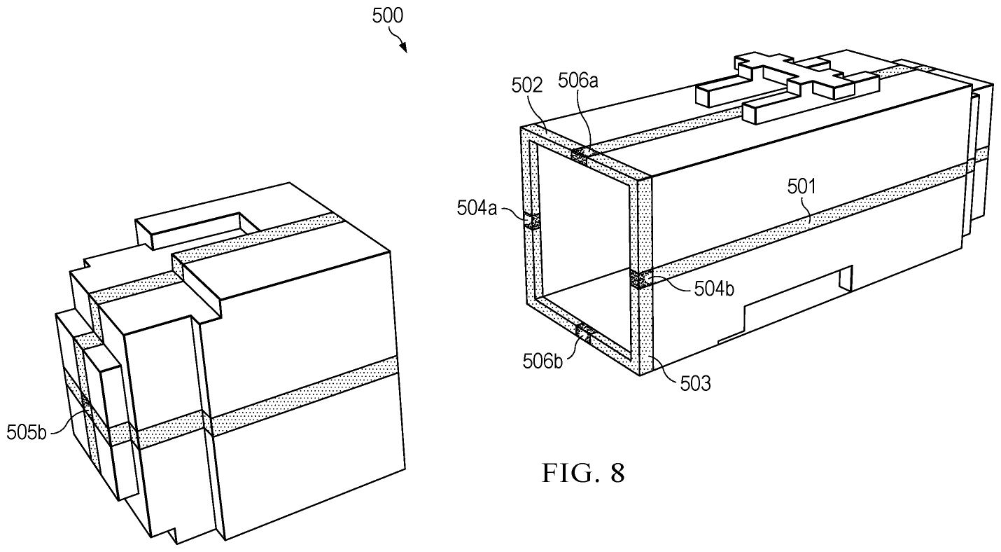

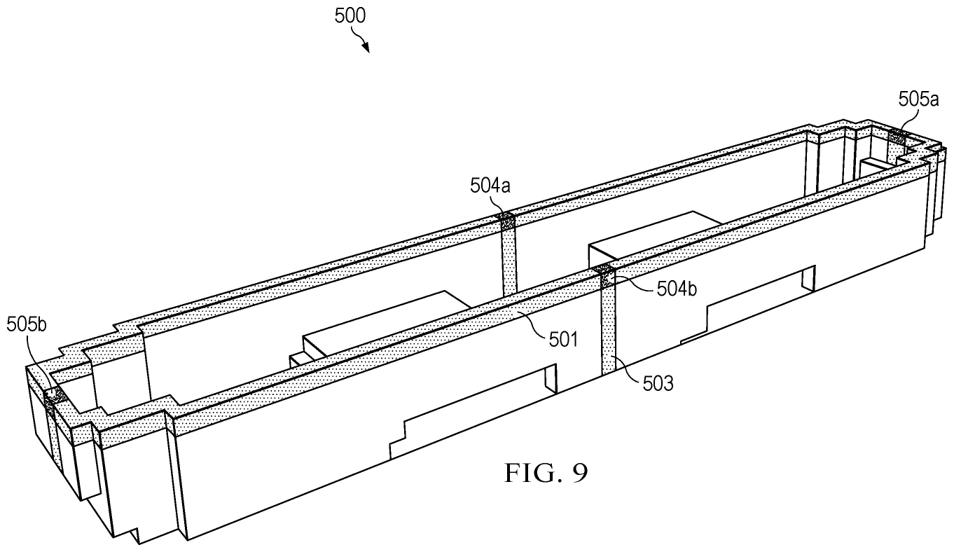

In this example use case, a renderer is tasked to appropriately render the sound of a virtual tram in an VR/AR/XR/MR scene. The tram could be seen moving on a busy road. A tram cannot be modelled by a single point source since the audio originating from a tram comes from several parts distributed along the tram's length. Initially, a “tram” object (FIG. 5) in a VR/AR/XR/MR scene and the accompanying “audio source(s) with an extent” to represent the sound of a “tram” may be specified by a scene creator as part of a “Scene Description” of the VR/AR/XR/MR scene. The specified “extent” model representing the tram for audio rendering is shown in FIG. 6 as an example. FIGS. 7, 8 and 9 depict a possible embodiment when applying the method illustrated in FIG. 1 to determine a set of target audio source locations, 504a, 504b, 505a, 505b, 506a, 506b in the proximity of the extent. Subsequently, the actual target audio sources which correspond to those locations are generated. In this context, FIGS. 8 and 9 are taken from FIG. 7 by cutting the tram extent representation to show the target audio source locations. This way, the sound of a tram in a VR/AR/XR/MR scene results from the rendering of those target audio sources.

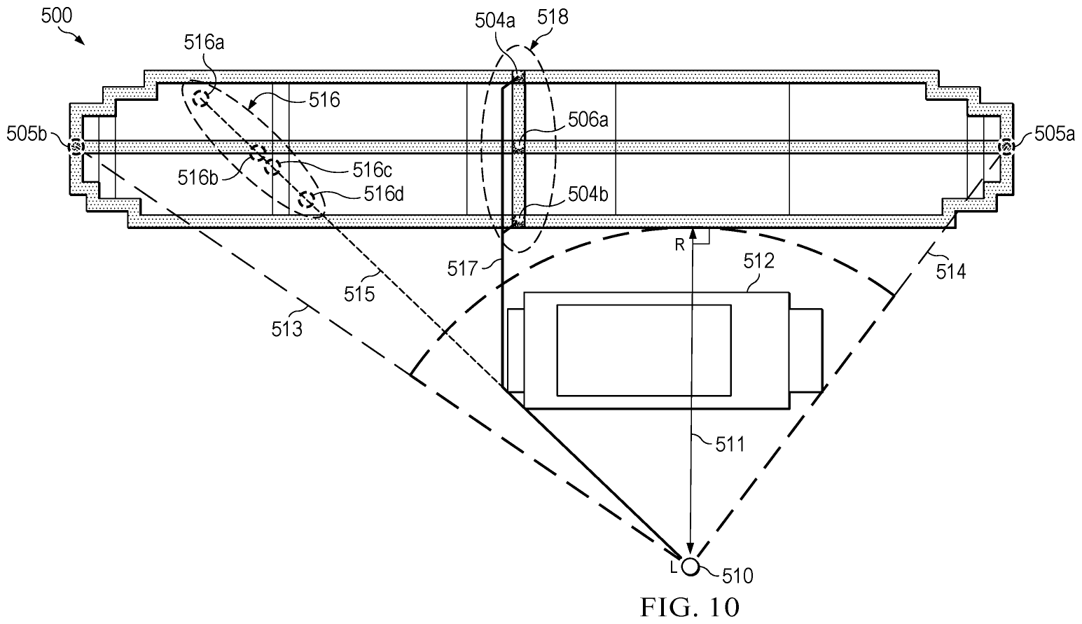

Referring now to the example of FIG. 10, in an embodiment, the method may further include obtaining coordinates of a listener location, 510, and rendering audio source signals of the allocated audio sources based on a reference distance, 511, between the listener position, 510, and the 3D extent, 500. For example, it may be subtracted from the listener-to-object distance (L, P) the distance from the listener L to the closest point R of extent VOX, where |L−R|==min(|L−VOX|).

In some embodiments, the rendering may further include rendering the (point) audio source signals based on (voxel-based) occlusion and diffraction modeling. That is, for example, a selected subset of point audio sources {P^{max}_{x,y,z}, P^{min}_{x,y,z}} may be rendered applying voxel-based occlusion and diffraction modelling. The example of FIG. 10 shows the 3D extent representation of the tram, 500, occluded by an obstacle, 512. Coordinates 504a, 504b, 506a and 518 are thus occluded and, as a result, a set of virtual coordinates, 516, 516a-d, is generated by means of diffraction modeling.

The 3D extent modeling method described herein assumes the application of diffraction modeling. However, the method can also be used without the application of diffraction modeling. In this case, the method is applied to the 3D extent subset visible to the listener, 510. The following methods can be used to obtain the subset “visible” (visible implies the absence of acoustic occluder between the listener and the corresponding point) to the listener: ray tracing based methods or by checking occlusion on the line between the listener and a subset of a 3D extent representation. This subset can be determined by a Monte Carlo or any other sub-sampling methods.

### Example Algorithm

In other words, a method of rendering audio in an audio scene may be described as follows. The following represents an example implementation of the method illustrated in FIG. 1.

This assumes that the decoder already received the “Scene Description” information containing aspects indicated in step S101.

### Given

### Scene Description:

listener position coordinates L
3D extent material IDs (representing audio object 3D extent geometry approximation)
a set of 3D grid indices VOX (representing set of 3D extent)
a set of M audio signals (mono, stereo, etc.)

### Modelling Settings:

minimal distance Δₘᵢₙ between two ‘joint’ point audio sources
mapping matrix F to assign audio signals to obtained point source position (and gains)
reference distance

### Find

number of point audio sources N=[1, . . . , 6] and their coordinates P^{1, . . . , N}
map audio signals S^{1, . . . , M} to positions P^{1, . . . , N} and gains

### Solution

Determine (step S102) the 3D extent center representation coordinates C_{x,y,z} of the voxel-based 3D extent representations VOX_{x,y,z}, e.g., using the “min/max (geometric center)” approach:

$${C}_{x , y , z} = round ( \vert {V}_{x , y , z}^{max} - {V}_{x , y , z}^{min} \vert / 2 ) \\ where {V}_{x , y , z}^{max} = max ( {VOX}_{x , y , z} ) , {V}_{x , y , z}^{min} = min ( {VOX}_{x , y , z} )$$

(Note: it is also possible to use different center representation such as the “center of mass” point (centroid)). See the example of FIG. 2.

Center representation is needed to extract three characteristic dimensions from three-dimensional 3D extent representation.

Determine (step S103) 3D extent characteristic dimension representation by the following extreme points D^{max}_{x,y,z} and D^{min}_{x,y,z}.

$${D}_{x}^{max} = [ {V}_{x}^{max} , {C}_{y} , {C}_{z} ] , {D}_{x}^{min} = [ {V}_{x}^{min} , {C}_{y} , {C}_{z} ] , {D}_{y}^{max} = [ {C}_{x} , {V}_{y}^{max} , {C}_{z} ] , {D}_{y}^{min} = [ {C}_{x} , {V}_{y}^{min} , {C}_{z} ] , {D}_{z}^{max} = [ {C}_{x} , {C}_{y} , {V}_{z}^{max} ] , {D}_{z}^{min} = [ {C}_{x} , {C}_{y} , {V}_{z}^{min} ] .$$

(Note: it is also possible to use different characteristic dimension representation such as the offsets from the center representation).

Determine (step S104) 3D extent joint point source coordinates P^{max}_{x,y,z} and P^{min}_{x,y,z}.
where P^{max}ₓ=[p^{max}ₓ, C_{y}, C_{z}] is the voxel closest to D^{max}ₓ on the line [D^{max}ₓ, D^{min}ₓ) which is not an “occluder” voxel for this audio object
where p^{min}ₓ=[p^{min}ₓ, C_{y}, C_{z}] is the voxel closest to D^{min}ₓ on the line (D^{max}ₓ, D^{min}ₓ] and which is not an “occluder” voxel for this audio object

The same procedure can be applied to get P^{max}_{y,z} and P^{min}_{y,z}. A “not an occluder” voxel can be defined to be either P^{min}_{x,y,z}∈VOX_{x,y,z} (FIG. 4) or P^{max}_{x,y,z}∈VOX_{x,y,z}|AIR_{x,y,z} (FIG. 3), where AIR_{x,y,z} is a sound transmission media such as air and/or water.

Calculate the number N=[1, . . . , 6] of point audio sources by considering 3 variables:

$${W}_{x , y , z} = \vert {P}_{x , y , z}^{max} - {P}_{x , y , z}^{min} \vert$$

The ‘x-’, ‘y-’, ‘z-’ pair of audio sources P^{max}_{x,y,z} and P^{min}_{x,y,z} is considered for 3D extent modelling, if W_{x,y,z}>Δₘᵢₙ. This is done to prevent phasing audio artifact caused by two correlated audio signals rendered too close to each other.

If all W_{x,y,z}≤Δmin, then 3D extent is not modelled and the audio object is represented by a single audio point source positioned in the voxel C_{x,y,z}.

Obtain, based on the bitstream payload, a mapping of M audio signals S^{1, . . . , M} to position coordinates P^{1, . . . , 6}, such as the example mapping given in Table 1 above. For example, the mapping M may be read or extracted from the bitstream in some implementations.

Assign appropriate signal gains based on the number of selected audio sources (to ensure energy preservation).

Render selected subset of point audio sources {P^{max}_{x,y,z}, P^{min}_{x,y,z}} applying voxel-based occlusion and diffraction modelling (see FIG. 10 as an example)

Apply reference distance handling, i.e., subtract from the listener-to-object distance (L, P) the distance from the listener L to the closest point R of extent VOX, where |L−R|==min(|L−VOX|)

Render selected subset of point audio sources {Pmaxx,y,z, Pminx,y,z} applying voxel-based occlusion and diffraction modelling.

The rendering may be performed by a renderer capable of simulating acoustic occlusion and diffraction modelling.

FIG. 10 shows a 3D extent representation of an object, i.e., tram, occluded by an obstacle as an example of how the diffraction processing may be applied to the methods described herein. The points in the middle are occluded and, as a result, a set of virtual points is generated by means of diffraction modeling. 513 and 514 are the view lines which are not obstructed by the occluder 512. 515 is the direction (azimuth) from which the objects 518 are going to be perceived. These objects are then perceived (modelled) as 516. Consequently, those coordinates 504a, 504b, 506a, 506b (missing in the Fig) belonging to 518 are modelled by 516a, 516d, 516b, 516c belonging to 516.

The 3D extent modeling method described assumes the application of diffraction modeling.

However, the method can also be used without the application of diffraction modeling. In this case, the method is applied to the 3D extent subset visible to the listener. The following methods can be used to obtain the subset “visible” (visible implies the absence of acoustic occluder between the listener and the corresponding point) to the listener: ray tracing based methods or by checking occlusion on the line between the listener and a subset of 3D extent representation. This subset can be determined by a Monte Carlo or any other sub-sampling methods.

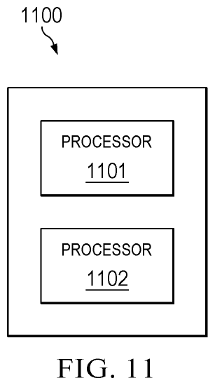

Referring to the example of FIG. 11, an apparatus 1100 including one or more processors 1101, 1102 according to embodiments of the disclosure is illustrated. The one or more processors 1101, 1102 may be configured to carry out the methods described herein.

A computing device implementing the techniques described above can have the following example architecture. Other architectures are possible, including architectures with more or fewer components. In some implementations, the example architecture includes one or more processors (e.g., dual-core Intel® Processors), one or more output devices (e.g., LCD), one or more network interfaces, one or more input devices (e.g., mouse, keyboard, touch-sensitive display) and one or more computer-readable mediums (e.g., RAM, ROM, SDRAM, hard disk, optical disk, flash memory, etc.). These components can exchange communications and data over one or more communication channels (e.g., buses), which can utilize various hardware and software for facilitating the transfer of data and control signals between components.

The term “computer-readable medium” refers to a medium that participates in providing instructions to processor for execution, including without limitation, non-volatile media (e.g., optical or magnetic disks), volatile media (e.g., memory) and transmission media. Transmission media includes, without limitation, coaxial cables, copper wire and fiber optics.

Computer-readable medium can further include operating system (e.g., a Linux® operating system), network communication module, audio interface manager, audio processing manager and live content distributor. Operating system can be multi-user, multiprocessing, multitasking, multithreading, real time, etc. Operating system performs basic tasks, including but not limited to: recognizing input from and providing output to network interfaces and/or devices; keeping track and managing files and directories on computer-readable mediums (e.g., memory or a storage device); controlling peripheral devices; and managing traffic on the one or more communication channels. Network communications module includes various components for establishing and maintaining network connections (e.g., software for implementing communication protocols, such as TCP/IP, HTTP, etc.).

Architecture can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Unless specifically stated otherwise, as apparent from the following discussions, it is appreciated that throughout the present disclosure discussions utilizing terms such as “processing”, “computing”, “calculating”, “determining”, “analyzing” or the like, refer to the action and/or processes of a computer or computing system, or similar electronic computing devices, that manipulate and/or transform data represented as physical, such as electronic, quantities into other data similarly represented as physical quantities.

Reference throughout this disclosure to “one example embodiment”, “some example embodiments” or “an example embodiment” means that a particular feature, structure or characteristic described in connection with the example embodiment is included in at least one example embodiment of the present disclosure. Thus, appearances of the phrases “in one example embodiment”, “in some example embodiments” or “in an example embodiment” in various places throughout this disclosure are not necessarily all referring to the same example embodiment. Furthermore, the particular features, structures or characteristics may be combined in any suitable manner, as would be apparent to one of ordinary skill in the art from this disclosure, in one or more example embodiments.

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted”, “connected”, “supported”, and “coupled” and variations thereof are used broadly and encompass both direct and indirect mountings, connections, supports, and couplings.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of example embodiments of the present disclosure, various features of the present disclosure are sometimes grouped together in a single example embodiment, Fig., or description thereof for the purpose of streamlining the present disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed example embodiment. Thus, the claims following the Description are hereby expressly incorporated into this Description, with each claim standing on its own as a separate example embodiment of this disclosure.

Furthermore, while some example embodiments described herein include some, but not other features included in other example embodiments, combinations of features of different example embodiments are meant to be within the scope of the present disclosure, and form different example embodiments, as would be understood by those skilled in the art. For example, in the following claims, any of the claimed example embodiments can be used in any combination.

In the description provided herein, numerous specific details are set forth. However, it is understood that example embodiments of the present disclosure may be practiced without these specific details. In other instances, well-known methods, structures and techniques have not been shown in detail in order not to obscure an understanding of this description.

Thus, while there has been described what are believed to be the best modes of the present disclosure, those skilled in the art will recognize that other and further modifications may be made thereto without departing from the spirit of the present disclosure, and it is intended to claim all such changes and modifications as fall within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

Various aspects and implementations of the present disclosure may also be appreciated from the following enumerated example embodiments (EEEs), which are not claims.

EEE1. A method of modelling extended audio objects for audio rendering in a virtual or augmented reality environment, the method comprising:
determining a 3D extent center representation of a voxel based 3D extent representation;
determining 3D extent characteristic dimension representation based on the 3D extent representation;
determining 3D extent joint point source coordinates based on the 3D extent characteristic dimension representation or the 3D extent center representation;

EEE2. The method of EEE1, further comprising receiving a mapping of M audio signals to position coordinates; and assigning signal gains of the M audio signals to the point sources.

EEE3. The method of EEE1, further comprising rendering the point sources based on voxel-based occlusion and diffraction modeling.

EEE4. The method of EEE1, wherein the center representation may be determined based on the geometric center of voxels or by the centroid approach.

EEE5. The method of EEE1, wherein dimension representation may be based on extreme points or by calculating corresponding offsets from the center.

EEE6. The method of EEEs 1-5, wherein the method is applied to a subset of the voxel based 3D extent representation.

EEE7. The method of EEE6, wherein the subset of the voxel based 3D extent representation corresponds to acoustically non-occluded (visible) voxels.

EEE8. A non-transitory computer program comprising instructions that, when executed by a processor, cause the processor to carry out the method according to any one of EEEs 1-7.

EEE9. An apparatus configured to perform the method of EEEs 1-7.

1. A method of rendering audio in an audio scene, the method comprising:
receiving a voxel-based audio scene representation of the audio scene, the audio scene representation including an indication of extent voxels representing a 3D extent together with a plurality of audio source signals for audio sources associated with the 3D extent;
obtaining coordinates of an intersection point inside the 3D extent;
determining one or more line-segments running through the intersection point and extending along respective coordinate directions of the audio scene representation, wherein end points each line segment are determined based on coordinates of one or more of the extent voxels; and
allocating (S104) audio sources among the plurality of audio sources to audio source locations within the audio scene based on the one or more line-segments.

2. The method of claim 1, wherein the intersection point is one of a geometric center of the 3D extent and the center of gravity of the 3D extent.

3. The method of claim 1, wherein end points of each line segment are determined based on extremal coordinate values of the 3D extent along respective coordinate directions, such that lengths of the line segments correspond to maximum dimensions of projections of the 3D extent onto respective coordinate directions.

4. The method of claim 1, wherein the audio scene representation further indicates occluder voxels; and
wherein allocating the audio sources includes allocating the audio sources to coordinates within voxels other than the occluder voxels.

5. The method of claim 4, wherein the audio scene representation further indicates unfilled voxels; and
wherein allocating the audio sources includes allocating the audio sources to coordinates on respective line segments that are closest to the end points of the respective line segments and that are within extent voxels or unfilled voxels.

6. The method of claim 1, wherein allocating the audio sources further includes determining one or more possible target locations for allocating the audio sources, based on the line segments.

7. The method of claim 6, wherein the audio scene representation further indicates unfilled voxels; and
wherein determining the one or more possible target locations includes selecting coordinates for the one or more possible target locations that are closest to the end points of the respective line segments and that are within extent voxels or unfilled voxels.

8. The method of claim 6, wherein determining the one or more possible target locations includes selecting coordinates for the one or more possible target locations that are closest to the end points of the respective line segments and that are within extent voxels.

9. The method of claim 6, wherein the method further includes:
selecting the audio source locations from the possible target locations based on a predefined minimum distance between audio sources; and
allocating the audio sources among the plurality of audio sources to the selected audio source locations.

10. The method of claim 1, further including obtaining a mapping indicating an assignment of the audio source signals to the audio source locations.

11. The method of claim 10 further including assigning gains to the audio source locations based at least in part on the mapping.

12. The method of claim 1, wherein the method further includes:
obtaining coordinates of a listener location; and
rendering audio source signals of the allocated audio sources based on a reference distance between the listener position and the 3D extent.

13. The method of claim 12, wherein the rendering further includes rendering the audio source signals based on occlusion and diffraction modeling.

14. An apparatus for rendering audio in a voxel-based audio scene representation, the apparatus comprising:
one or more processors configured to:
receive a voxel-based audio scene representation of the audio scene, the audio scene representation including an indication of extent voxels representing a 3D extent together with a plurality of audio source signals for audio sources associated with the 3D extent;
obtain coordinates of an intersection point inside the 3D extent;
determine one or more line-segments running through the intersection point and extending along respective coordinate directions of the audio scene representation, wherein end points each line segment are determined based on coordinates of one or more of the extent voxels; and
allocate audio sources among the plurality of audio sources to audio source locations within the audio scene based on the one or more line-segments.

15. A non-transitory program comprising instructions that, when executed by a processor, cause the processor to carry out the method according to claim 1.

16. A non-transitory computer-readable storage medium storing the program according to claim 15.
